(19) United States
(12) Patent Application Publication
(10) Pub. No.: US 2024/0039316 A1
(43) Pub. Date: Feb. 1, 2024

(54) INFORMATION PROCESSING APPARATUS AND CONTROL METHOD

(71) Applicant: Lenovo (Singapore) Pte. Ltd., Singapore (SG)

(72) Inventors: Li Jhan Chien, Kanagawa (JP); Mitsuru Ogawa, Kanagawa (JP)

(73) Assignee: Lenovo (Singapore) Pte. Ltd., Singapore (SG)

(21) Appl. No.: 18/343,746

(22) Filed: Jun. 29, 2023

(30) Foreign Application Priority Data
Jul. 26, 2022 (JP) 2022-118434

(51) Int. Cl. H02J 7/00; G06F 1/28

(52) U.S. Cl. CPC H02J 7/0047; G06F 1/28

(57) ABSTRACT

An information processing apparatus includes a system device; a controller; a battery; a converter configured to convert an input voltage into an intermediate voltage at a predetermined voltage ratio, the input voltage is a voltage of input power from a power adapter; and a power feeder. The power feeder is configured to supply part or all of intermediate power that is power supplied from the converter, to the system device as system supply power; and charge the battery with part of the intermediate power left unsupplied to the system device, as charging power. The controller is configured to monitor a charging voltage and the system supply power, the charging voltage is a voltage of the charging power; and determine the input voltage based on the charging voltage and the system supply power.

### CROSS-REFERENCE TO RELATED APPLICATIONS

This application claims priority to Japanese Patent Application No. 2022-118434 filed on Jul. 26, 2022, the contents of which are hereby incorporated herein by reference in their entirety.

### BACKGROUND OF THE INVENTION

### Field of the Invention

The present invention relates to an information processing apparatus and a control method, for example, a technology of controlling power supply to an information processing apparatus.

### Description of the Related Art

An information processing apparatus such as a personal computer (PC) includes an arithmetic processing unit (processor) as a system device forming a computer system. The arithmetic processing unit is a device that executes various arithmetic processing according to a program. A central processing unit (CPU) is typically employed as a system device. In the system device, faster processing consumes more power. Power consumption varies greatly depending on the required functions. Hence, function enhancement in power supply to information processing apparatuses has been promoted.

For example, the electronic apparatus described in Japanese Unexamined Patent Application Publication No. 2015-64838 measures the system load power of a secondary battery, compares the measured power with a first threshold and a smaller second threshold, and operates in any of a first power range, a second power range, and a third power range depending on the comparison result during drive by the secondary battery. The power in the first power range is greater than the power in the second power range, and the power in the second power range is greater than the power in the third power range.

In the power reception/supply standard USB PD (Power Delivery), the range of power that can be supplied is extended so that power can be supplied up to 240 W using a USB Type-C cable. The range from 100 W to 240 W, which is an extended part of the standard power range (SPR) with which power is suppliable conventionally, is called an extended power range (EPR). The use of USB PD enables not only supply of sufficient power for the operation of a large-capacity system such as a PC for games but also power supply to other peripheral devices. It is therefore possible to use not only a dedicated power adapter for power supply from a commercial power source but also a lighter and smaller power adapter.

In a power circuit that achieves an extended power range, the voltage of power supplied to a system device is variable (adjustable voltage supply (AVS)). In AVS, the input voltage of power supplied from an external power source can be selected from a plurality of voltage candidates that are preset fixed values. When dropping the input voltage to the supply voltage to the system device, if the selected voltage is higher, the power loss tends to be greater. Moreover, temperature rise due to heat generation is often noticeable.

### SUMMARY OF THE INVENTION

An information processing apparatus according to a first aspect of the present invention includes: a system device; a controller; a battery; a converter configured to convert an input voltage into an intermediate voltage at a predetermined voltage ratio, the input voltage being a voltage of input power from a power adapter; and a power feeder configured to: supply part or all of intermediate power that is power supplied from the converter, to the system device as system supply power; and charge the battery with part of the intermediate power left unsupplied to the system device, as charging power, wherein the controller is configured to: monitor a charging voltage and the system supply power, the charging voltage being a voltage of the charging power; and determine the input voltage based on the charging voltage and the system supply power.

In the information processing apparatus, when the intermediate power is less than the system supply power, power discharged from the battery may be supplied to the system device.

In the information processing apparatus, the controller may be configured to determine the input voltage based on larger power out of the charging power and the system supply power.

In the information processing apparatus, the controller may be configured to: change the input voltage to a system supply voltage estimated from the system supply power, when a difference between the system supply power and the charging power is greater than or equal to a predetermined first limit value; and determine the input voltage to be the charging voltage, when the difference between the charging power and the system supply power is greater than or equal to a predetermined second limit value.

In the information processing apparatus, the controller may be configured to estimate the charging power using the charging voltage, a reciprocal of the voltage ratio, and a rated current of the power adapter.

In the information processing apparatus, the power adapter or the converter may include a measuring instrument configured to measure an input current from the power adapter.

A control method according to a second aspect of the present invention is a control method executed by an information processing apparatus that includes: a system device; a battery; a converter configured to convert an input voltage into an intermediate voltage at a certain voltage ratio, the input voltage being a voltage of input power from a power adapter; and a power feeder configured to: supply part or all of intermediate power that is power supplied from the converter, to the system device as system supply power; and charge the battery with part of the intermediate power left unsupplied to the system device, as charging power, the control method including: a first step of monitoring a charging voltage that is a voltage of the charging power and power consumption of the system device; and a second step of determining the input voltage based on the charging voltage and the power consumption.

The above-described aspects of the present invention can reduce power loss while achieving an extended power range of suppliable power.

### BRIEF DESCRIPTION OF THE DRAWINGS

FIG. 1 is a schematic block diagram illustrating an example of the hardware structure of an information processing apparatus according to one or more embodiments.

FIG. 2 is a schematic block diagram illustrating an example of the structure of a power supply system according to one or more embodiments.

FIG. 3 is a flowchart illustrating an input voltage control method according to one or more embodiments.

FIG. 4 is a flowchart illustrating a first example of an input voltage estimation method according to one or more embodiments.

FIG. 5 is a state transition diagram illustrating a second example of an input voltage estimation method according to one or more embodiments.

FIG. 6 is a diagram illustrating an example of a range of input voltage and intermediate voltage.

FIG. 7 is a diagram illustrating a first control example of input voltage according to one or more embodiments.

FIG. 8 is a diagram illustrating a second control example of input voltage according to one or more embodiments.

FIG. 9 is a diagram illustrating an example of system supply power according to a comparative example.

FIG. 10 is a diagram illustrating the relationship between the intermediate voltage and the system supply power according to one or more embodiments.

FIG. 11 is a diagram illustrating the relationship between the voltage difference and the system supply voltage according to one or more embodiments.

FIG. 12 is a diagram illustrating the relationship between the power loss and the system supply power according to one or more embodiments.

FIG. 13 is a diagram illustrating the relationship between the power loss and the system supply power according to a comparative example;

### DETAILED DESCRIPTION OF THE INVENTION

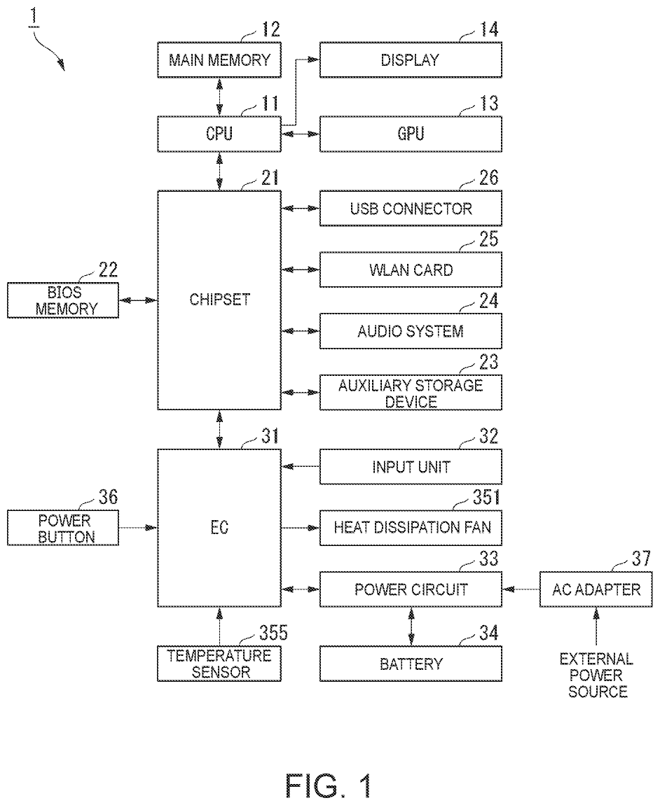

One or more embodiments of the present invention will be described below, with reference to the drawings. First, an overview of an information processing apparatus 1 according to one or more embodiments of the present invention will be described below. FIG. 1 is a schematic block diagram illustrating an example of the hardware structure of the information processing apparatus 1 according to one or more embodiments. In the example in FIG. 1, the information processing apparatus 1 is implemented as a PC. The information processing apparatus 1 includes a CPU 11, a main memory 12, a graphic processing unit (GPU) 13, a display 14, a chipset 21, a BIOS (Basic Input Output System) memory 22, an auxiliary storage device 23, an audio system 24, a WLAN (Wireless Local Area Network) card 25, a USB (Universal Serial Bus) connector 26, an embedded controller (EC) 31, an input unit 32, a power circuit 33, a battery 34, a heat dissipation fan 351, a temperature sensor 355, a power button 36, and an alternating current (AC) adapter 37.

The CPU 11 is a processor that forms the core of system devices included in the information processing apparatus 1. The CPU 11 is a processor that executes various arithmetic processing indicated by instructions written in software (programs). The CPU 11 executes processes indicated by various software such as an operating system (OS), BIOS, and application programs (referred to as “applications” herein). Executing a process indicated by a command written in software is also referred to as “executing software”.

The main memory 12 is writable memory used as a read area for the execution program of the processor or a work area for writing processing data of the execution program. The main memory 12 is, for example, composed of a plurality of dynamic random access memory (DRAM) chips. The execution program includes an OS, various drivers for operating hardware such as peripheral devices, various services/utilities, and applications.

The GPU 13 is a processor that mainly executes real-time image processing. The GPU 13 processes drawing instructions from the CPU 11, and writes the processed drawing information to a video memory (not illustrated). The GPU 13 reads the drawing information from the video memory, and outputs display data indicating the drawing information (display information) to the display 14 via the CPU 11 (image processing). The CPU 11 executes a graphic driver on the OS, controls the operation of the GPU 13, and implements image processing indicated by the OS, applications, and other programs. The number of GPUs 13 is not limited to one, and may be two or more. The GPU 13 may share part of processing with the CPU 11 and execute parallel arithmetic processing other than image processing. The GPU 13 operates intermittently and tends to repeat operation start and operation end irregularly, unlike the CPU 11.

The CPU 11, the main memory 12, and the GPU 13 function as system devices that form the core computer system of the information processing apparatus 1, i.e. the host system. In other words, the computer system of the information processing apparatus 1 includes the system devices as hardware and software such as an OS and schedule tasks.

The display 14 displays a display screen based on the display data output from the CPU 11. The display 14 may be, for example, a liquid crystal display (LCD), an organic light emitting diode (OLED) display, or the like.

The chipset 21 includes one or more controllers, and is connectable to a plurality of devices so as to be able to input and output various data. The controller is any one of bus controllers such as USB, Serial ATA (Advanced Technology Attachment), SPI (Serial Peripheral Interface) bus, PCI (Peripheral Component Interconnect) bus, PCI-Express bus, and LPC (Low Pin Count), or a combination thereof. Examples of the plurality of devices to which the chipset 21 is connected include the below-described BIOS memory 22, auxiliary storage device 23, audio system 24, WLAN card 25, USB connector 26, and EC 31.

The BIOS memory 22 is composed of electrically rewritable nonvolatile memory. Examples of such nonvolatile memory include EEPROM (Electrically Erasable Programmable Read Only Memory) and flash ROM (Read Only Memory). The BIOS memory 22 stores BIOS, firmware for controlling the operations of devices such as the EC 31, etc. BIOS is firmware for performing basic input/output for system devices. Herein, BIOS may also include firmware defined according to the specifications in UEFI (Unified Extensible Firmware Interface).

The auxiliary storage device 23 permanently stores various data. The stored data includes various programs that can be executed by the CPU 11 and the GPU 13, parameters, data used for various processes, and data obtained by various processes. The auxiliary storage device 23 may be, for example, a hard disk drive (HDD) or a solid state drive (SSD). The auxiliary storage device 23 includes any of various nonvolatile memories. For example, flash memory is used as nonvolatile memory. Various programs may include, for example, any one or a combination of an OS, drivers, firmware, and applications.

The audio system 24 is connected to a microphone and a speaker (not illustrated), and can record, reproduce, and output audio data. The microphone and the speaker may be included in the information processing apparatus 1 or provided separately from the information processing apparatus 1, for example. The WLAN card 25 is connected to a wireless LAN or to another network via a wireless LAN, and can transmit and receive various data to and from a device to which the WLAN card 25 is connected.

The USB connector 26 is a connector for connecting various peripheral devices using USB.

The EC 31 is a one-chip microcomputer that monitors and controls the status of various devices (peripheral devices, sensors, etc.) regardless of the operation state of the host system that forms the core of the information processing apparatus 1. The EC 31 includes a CPU other than the CPU 11, a RAM other than the main memory 12, a ROM, A/D (Analog-to-Digital) input terminals of a plurality of channels, D/A (Digital-to-Analog) output terminals, a timer, and digital input/output terminals (not illustrated). The digital input/output terminals of the EC 31 are connected to the input unit 32, the power circuit 33, the heat dissipation fan 351, and the like, and the EC 31 can control their operations.

The EC 31 may also control power consumption by changing the clock frequency of one or both of the processors, i.e. the CPU 11 and the GPU 13, and controlling the average processing speed, etc. via the chipset 21.

The input unit 32 includes an input device that detects a user's operation and outputs an operation signal corresponding to the detected operation to the EC 31. Examples of the input unit 32 include a keyboard and a touch pad. A touch sensor included in the input unit 32 may overlap the display 14 as a display unit to form a touch panel.

The power circuit 33 converts the voltage of DC power supplied from the AC adapter 37 or the battery 34 into the voltage required for the operation of each device included in the information processing apparatus 1, and supplies the power having the converted voltage to a destination device. The power circuit 33 supplies power under the control of the EC 31. The power circuit 33 includes a converter that converts the voltage of the power supplied thereto, and a power feeder that supplies the power of the converted voltage to the battery 34. In the case where power is supplied from the AC adapter 37, the power feeder supplies power left unsupplied in each device to the battery 34. In the case where power is not supplied from the AC adapter 37 or in the case where power supplied from the AC adapter 37 is insufficient, the power feeder supplies power discharged from the battery 34 to each device as operating power.

The battery 34 is, for example, a secondary battery. The secondary battery is a storage battery that is chargeable and dischargeable. An example of the secondary battery is a lithium ion battery.

The heat radiation fan 351 includes fins (wings) and a motor. The motor rotates the fins under the control of the EC 31. Due to the rotation of the fins, air flows into the chassis of the information processing apparatus 1, heat-exchanges with each part, and is discharged.

The temperature sensor 355 detects the temperature of the CPU 11, and outputs a temperature signal indicating the detected temperature to the EC 31. The EC 31 controls the operation of the heat dissipation fan based on the temperature notified from the temperature sensor 355.

The power button 36 controls power-on and power-off of the entire information processing apparatus 1 each time a press operation is received. The power button 36 outputs a press signal indicating press to the EC 31. Upon receiving the press signal from the power button 36 while the information processing apparatus 1 is in a power-off state, the EC 31 causes the power circuit 33 to start supplying power to each device in the information processing apparatus 1 (power on).

The AC adapter 37 converts AC power supplied from an external power source into DC power with a constant voltage, and supplies the converted power to the power circuit 33. The AC adapter 37 is connected to the power circuit 33 and the EC 31 so as to be able to input and output various data signals. The AC adapter 37 includes a mounting fixture that is detachably attachable to the chassis of the information processing apparatus 1 including the power circuit 33. The mounting fixture includes an interface capable of transmitting both power and data according to a predetermined standard. An example of the predetermined standard is USB Type-C.

Typically, the power consumption of the system devices is main power consumption and also tends to vary significantly with time, among the devices included in the information processing apparatus 1 and the devices connected to these internal devices by wire. Power supply from the power circuit 33 is controlled mainly based on the power consumption state in the system devices. The power circuit 33 detects the electromotive force of the battery 34. The electromotive force of the battery 34 corresponds to the potential difference between the positive electrode and the negative electrode. For example, when charging the battery 34, the power circuit 33 determines the charging voltage to the battery 34 so as to be higher than the electromotive force of the battery 34 and lower than or equal to the voltage supplied to the system device. When discharging the battery 34, the power circuit 33 determines the voltage supplied to the system device so as to be lower than the electromotive force of the battery 34.

The power consumption of a processor which is a system device is higher when the amount of processing indicated by the program being executed is larger. The processor, through execution of a predetermined program, monitors its own power consumption and varies one or both of the operating voltage and the operating frequency depending on the power consumption. For example, the CPU 11 sets rated power corresponding to the operation state of the host system in a register included in the CPU 11. The CPU 11 controls the operating voltage or the operating frequency so that the moving average value of power consumption up to this point will not exceed the rated power. The CPU 11 can also control the power consumption of the GPU 13 by the same method. The CPU 11 selects one level of operation mode from a plurality of operation modes determined in advance, using a known method. For example, the CPU 11 selects one of a standard mode and a low power mode. The low power mode is an operation mode lower in power consumption (rated power) than the standard mode.

For example, for an application running in the foreground, the operation mode is selected based on whether there is user operation, whether there is screen display, their durations, and the like. For example, when no user operation has been detected for at least a predetermined time and no new screen display has been made for at least a predetermined time, the CPU 11 changes the operation mode from the standard mode to the low power mode. Upon detecting any user operation, the CPU 11 changes the operation mode from the low power mode to the standard mode. The standard mode may be further classified into a plurality of levels of operation modes that differ in rated power. When the moving average value of the power consumption of the processor is higher, the CPU 11 selects an operation mode with higher rated power. Such a process may be implemented by executing any form of program such as a driver, utility, or firmware. The CPU 11 outputs mode information indicating the determined operation mode to the EC 31.

The EC 31 may control the operation of the power circuit 33 based on the mode information received from the CPU 11. Data indicating voltage control information for each operation mode may be set in the EC 31 in advance. The voltage control information indicates each device to which power is to be supplied and the voltage for the device. The EC 31 outputs voltage control information corresponding to the operation mode notified by the mode information to the power circuit 33. The power circuit 33 supplies power having a voltage indicated for each device by the voltage control information received from the EC 31.

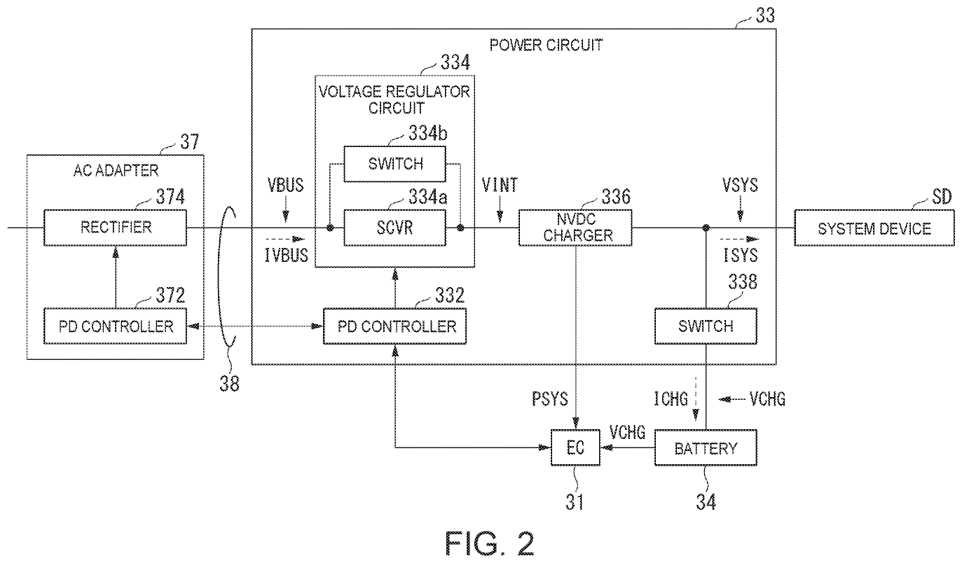

Next, an example of the structure of a power supply system according to one or more embodiments will be described below. FIG. 2 is a schematic block diagram illustrating an example of the structure of the power supply system according to one or more embodiments. The power supply system illustrated in FIG. 2 includes the power circuit 33 and the AC adapter 37. Devices to which power is supplied other than a system device SD are omitted in the drawing. The power circuit 33 is connected to each of the AC adapter 37 and the EC 31 so as to be able to transmit and receive various data. This connection complies with the USB Type-C standard, for example. The power circuit 33 and the AC adapter 37 are connected using a base line 38. The base line 38 includes a power line and a signal line, which are integrated in parallel. The base line 38 is, for example, a USB Type-C cable. The power line transmits power from the AC adapter 37 to the power circuit 33. The signal line transmits various data signals between the AC adapter 37 and the power circuit 33.

The power circuit 33 includes a PD (Power Delivery) controller 332, a voltage regulator circuit 334, an NVDC (Narrow Voltage Direct Charging) power feeder 336, and a switch 338.

The AC adapter 37 includes a PD controller 372 and a rectifier 374.

The PD controller 372 sets input voltage VBUS indicated by an input voltage control signal received from the power circuit 33 via the signal line, in the rectifier 374.

The rectifier 374 rectifies AC power supplied from an external commercial power source and converts it into DC power. The voltage of the DC power is set input voltage VBUS. The rectifier 374 supplies the converted DC power to the power circuit 33 via the power line. In FIG. 2, IVBUS denotes the current (also referred to as “input current” herein) supplied from the rectifier 374 to the power circuit 33.

The rectifier 374 may limit input current IVBUS to not higher than a predetermined maximum value (e.g. 1 A to 5 A).

The AC adapter 37 may include a measuring instrument that measures input current IVBUS. The PD controller 372 may output input current information indicating measured input current IVBUS to the EC 31 via the power circuit 33.

The PD controller 372 may output current information indicating the rated current of the AC adapter 37 transmitted to the base line 38, to the EC 31 via the power circuit 33. The current information is used by the EC 31 to estimate the charging power, as described later.

The PD controller 332 is connected to the EC 31 and the AC adapter 37 so as to be able to input and output data signals. The PD controller 332 outputs an input voltage control signal received from the EC 31 to the AC adapter 37, for example.

The PD controller 332 may detect the model of the AC adapter 37 connected to the PD controller 332, and determine the voltage ratio according to the detected model. For example, the PD controller 332 receives a response signal to the connection request signal to the PD controller 372 in the AC adapter 37, and identifies the model notified by the received response signal. A table indicating the voltage ratio for each model is set in the PD controller 332 in advance, and the voltage ratio corresponding to the detected device can be identified with reference to the set table. The voltage ratio corresponds to the ratio of intermediate voltage VINT to input voltage VBUS supplied from the AC adapter 37 to the voltage regulator circuit 334. Intermediate voltage VINT denotes the voltage of the power supplied from the voltage regulator circuit 334 to the NVDC feeder 336.

The PD controller 332 may determine, from a plurality of voltage ratios set in advance, a voltage ratio that is higher than or equal to the ratio of input voltage VBUS to the system supply voltage and is closest to the ratio. Thus, the power loss in the NVDC feeder 336 can be suppressed.

The PD controller 332 outputs a voltage ratio control signal indicating the determined voltage ratio to the voltage regulator circuit 334 and the EC 31.

In the case where the voltage regulator circuit 334 steps down input voltage VBUS to intermediate voltage VINT at a predetermined voltage ratio, the process of the PD controller 332 determining the voltage ratio and outputting the voltage ratio control signal to the voltage regulator circuit 334 may be omitted.

The voltage regulator circuit 334 steps down input voltage VBUS of power supplied from the AC adapter 37 at a predetermined voltage ratio (for example, 2:1), and supplies power having the stepped-down voltage as intermediate voltage VINT to the NVDC feeder 336 as intermediate power.

The voltage regulator circuit 334 includes a switched capacitor voltage regulator (SCVR) 334a and a switch 334b. The SCVR 334a and the switch 334b are connected in parallel.

The SCVR 334a steps down input voltage VBUS of power supplied from the AC adapter 37 at the voltage ratio indicated by the voltage control signal received from the PD controller 332. The SCVR 334a transmits intermediate power having stepped-down intermediate voltage VINT to the NVDC feeder 336.

The switch 334b can control whether to conduct the power supplied from the AC adapter 37 to the NVDC feeder 336 according to the voltage control signal received from the PD controller 332. The internal resistance of the SCVR 334a is set to be sufficiently higher than the internal resistance when the switch 334b is conducting. Therefore, when the switch 334b is turned off, the power supplied from the AC adapter 37 mainly passes through the SDVR 334a. Therefore, intermediate voltage VINT is controlled to either input voltage VBUS or the voltage stepped down at the voltage ratio indicated by the voltage control signal by opening or closing the switch 334b. In the case where the SCVR 334a steps down input voltage VBUS to intermediate voltage VINT at a predetermined voltage ratio, the switch 334b may have power cut off.

The NVDC feeder 336 supplies part or all of the intermediate power supplied from the voltage regulator circuit 334, to the system device SD. The NVDC feeder 336 charges the battery 34 with the power left unsupplied to the system device SD, via the switch 338.

The NVDC feeder 336 acquires target charging information about the voltage (also referred to as “charging voltage” herein) of power to charge the battery 34 from the EC 31. With the acquired target charging information, the respective target values of charging voltage VCHG and charging current ICHG are notified from the EC 31. The NVDC feeder 336 limits the total output current (ISYS+ICHG) of system supply current ISYS supplied to the system device SD and charging current ICHG to the battery 34 so that charging current ICHG will not exceed its target value. The NVDC feeder 336 determines system supply voltage VSYS based on the target value of charging voltage VCHG, and supplies power to the system device SD according to the target value of system supply current ISYS and system supply voltage VSYS determined. Here, system supply voltage VSYS is a value obtained by compensating for the voltage drop due to the switch 338 and wiring resistance with respect to the target value of charging voltage VCHG. The respective resistance values of the switch 338 and the wiring resistance required for the compensation of the voltage drop may be set in the NVDC feeder 336 in advance.

The NVDC feeder 336 includes a measuring instrument that measures intermediate voltage VINT and intermediate power IVINT of the power supplied from the SCVR 334a and charging voltage VCHG and charging current ICHG of the power actually charged to the battery 34. The NVDC feeder 336 calculates the product of the measured value of intermediate voltage VINT and the measured value of intermediate power IVINT as input power PIN. The NVDC feeder 336 calculates the product of the measured value of charging voltage VCHG and the measured value of charging current ICHG as charging power PCHG. The NVDC feeder 336 calculates the difference of charging power PCHG from input power PIN as system supply power PSYS. The NVDC feeder 336 outputs power supply information indicating determined system supply voltage VSYS to the EC 31.

The switch 338 supplies the power discharged from the battery 34 to the system device SD, in the case where no power is supplied from the NVDC feeder 336 or the power supplied from the NVDC feeder 336 is insufficient for the power consumption in the system device SD.

One end of the switch 338 is electrically connected to the NVDC feeder 336 and the system device SD. The other end of the switch 338 is electrically connected to the battery 34. The switch 338 includes, for example, a first rectifier, a second rectifier, a measuring instrument, and a switch. The first rectifier conducts current from the one end to the other end and cuts off current from the other end to the one end. The second rectifier conducts current from the other end to the one end and cuts off current from the one end to the other end. The measuring instrument detects the potential difference between the one end and the other end. The switch switches energization between the first rectifier and the second rectifier depending on whether the potential at the one end is higher than the potential at the other end based on the detected potential difference.

In the case where the PD controller 332 receives input current information from the AC adapter 37, the PD controller 332 may output the input current information to the EC 31. The power circuit 33 may include a measuring instrument that measures the current value of power supplied from the AC adapter 37. Instead of or in addition to the input current information received from the AC adapter 37, the PD controller 332 may output, to the EC 31, input current information indicating the current value measured by the measuring instrument in the power circuit 33 as input current.

The battery 34 charges the power supplied from the NVDC feeder 336 via the switch 338. The battery 34 includes a controller that determines the target value of charging voltage VCHG and the target value of charging current ICHG. For example, the controller includes a detector that detects the voltage and current indicating the electricity storage state in the battery 34, and determines the target value of charging voltage VCHG and the target value of charging current ICHG by a known electricity storage control method using parameters that indicate electrical characteristics such as internal resistance, capacitance, emergency stop voltage, and discharge stop voltage. The controller outputs target charging information indicating the determined target value of charging voltage VCHG and target value of charging current ICHG to the EC 31.

The EC 31 monitors the power supply information received from the NVDC feeder 336 and the target charging information received from the EC 31. The EC 31 determines input voltage VBUS based on the target value of charging voltage VCHG indicated by the target charging information and system supply power PSYS indicated by the power supply information. The EC 31 outputs an input voltage control signal indicating determined input voltage VBUS to the AC adapter 37 via the power circuit 33. The EC 31 outputs the target charging information received from the battery, to the NVDC feeder 336.

The EC 31 estimates charging power PADP_CHG based on charging voltage VCHG. Herein, estimated charging power PADP_CHG is also referred to as “estimated charging power PADP_CHG” or simply “estimating charging power”. For example, the EC 31 can calculate the product of charging voltage VCHG, the reciprocal of the voltage ratio in the voltage regulator circuit 334, and input current IVBUS as charging power PADP_CHG. Specifically, when charging voltage VCHG is 12 V, the voltage ratio of intermediate voltage VINT to input voltage VBUS is 2:1, and input current IVBUS is 5 A, estimated charging power PADP_CHG is 12 V×2×5 A=60 W. In the case where input current IVBUS is fixed at a certain value or limited to less than or equal to a maximum value, rated power Irated can be used as input current IVBUS set in advance.

In the case where input current IVBUS is variable, the EC 31 may use input current IVBUS notified by the input current information received from the AC adapter 37. Estimated charging power PADP_CHG can be regarded as power obtained by converting charging voltage VCHG into the same dimension as the input power supplied from the AC adapter 37. The power supplied to the system device among the devices is principal.

The EC 31 compares estimated charging power PADP_CHG and system supply power PSYS, and determines which of estimated charging power PADP_CHG and system supply power PSYS is greater. The EC 31 determines input voltage VBUS based on the larger power out of estimated charging power PADP_CHG and system supply power PSYS. The EC 31 determines a voltage obtained by converting the larger power into the same dimension as the input voltage, as input voltage VBUS. That is, the EC 31 can determine a voltage obtained by dividing the larger power by input current IVBUS and multiplying the result by the reciprocal of the voltage ratio, as input voltage VBUS.

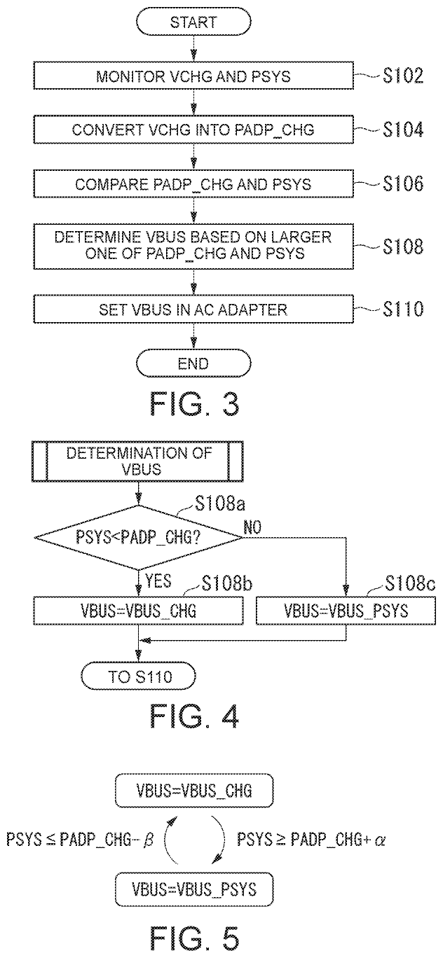

Next, an example of an input voltage control method according to one or more embodiments will be described below. FIG. 3 is a flowchart illustrating an example of an input voltage control method according to one or more embodiments.

(Step S102) The EC 31 monitors charging voltage VCHG notified from the battery 34 and system supply power PSYS notified from the NVDC feeder 336.

(Step S104) The EC 31 converts charging voltage VCHG into estimated charging power PADP_CHG of the same dimension as the system supply power.

(Step S106) The EC 31 compares estimated charging power PADP_CHG and system supply power PSYS to determine which of estimated charging power PADP_CHG and system supply power PSYS is larger.

(Step S108) The EC 31 determines a voltage obtained by converting the larger one of estimated charging power PADP_CHG and system supply power PSYS, as input voltage VBUS.

(Step S110) The EC 31 outputs an input voltage control signal indicating determined input voltage VBUS to the AC adapter 37. The PD controller 372 in the AC adapter 37 sets input voltage VBUS indicated by the input voltage control signal supplied from the EC 31, in the rectifier 374. The process in FIG. 3 then ends.

Next, an example of an input voltage determination method according to one or more embodiments will be described below. FIG. 4 is a flowchart illustrating a method of estimating input voltage VBUS in step S108.

(Step S108a) In the case where system supply power PSYS is less than estimated charging power PADP_CHG (step S108a: YES), the process advances to step S108b. In the case where system supply power PSYS is greater than or equal to estimated charging power PADP_CHG (step S108a: NO), the process advances to step S108c.

(Step S108b) The EC 31 determines voltage VBUS_CHG obtained by dividing estimated charging power PADP_CHG by input current IVBUS and multiplying the result by the reciprocal of the voltage ratio, as input voltage VBUS. The process then advances to step S110.

(Step S108c) The EC 31 determines voltage VBUS_PSYS obtained by dividing system supply power PSYS by input current IVBUS and multiplying the result by the reciprocal of the voltage ratio, as input voltage VBUS. The process then advances to step S110.

When the EC 31 simply compares the respective instantaneous values of estimated charging power PADP_CHG and system supply power PSYS, the magnitude relationship between the two values and consequently input voltage VBUS may fluctuate successively. Hence, instead of the respective instantaneous values of estimated charging power PADP_CHG and system supply power PSYS, the EC 31 may use moving average values for comparison and calculation of input voltage VBUS. Since the fluctuation in the magnitude relationship between system supply power PSYS and estimated charging power PADP_CHG is alleviated, stable input voltage VBUS is calculated. The power supply to the information processing apparatus 1 can thus be stabilized.

The EC 31 may calculate, as the moving average value, a simple average value or weighted average value of instantaneous values within a certain period up to the current time, or an exponential moving average value. The exponential moving average value corresponds to the sum of: the product of the difference between the current instantaneous value and a previous instantaneous value and a predetermined smoothing coefficient; and the previous instantaneous value. The smoothing coefficient is a predetermined positive real value greater than 0 and less than 1.

Although FIGS. 3 and 4 illustrate the case where the EC 31 simply determines input voltage VBUS based on the magnitude relationship between system supply power PSYS and estimated charging power PADP_CHG, the present invention is not limited to such.

As illustrated in FIG. 5, the EC 31 may determine voltage VBUS_PSYS as input voltage VBUS in the case where system supply power PSYS is greater than or equal to the sum of estimated charging power PADP_CHG and first limit value α, i.e. in the case where the difference of estimated charging power PADP_CHG from system supply power PSYS is greater than or equal to first limit value α.

In the case where system supply power PSYS is greater than or equal to the difference of second limit value β from estimated charging power PADP_CHG, i.e. in the case where the difference of system supply power PSYS from estimated charging power PADP_CHG is greater than or equal to second limit value β, the EC 31 determines voltage VBUS_CHG as input voltage VBUS.

A positive real number greater than 0 is set as first limit value α in advance. When system supply power PSYS is significantly greater than charging power PADP_CHG, voltage VBUS_PSYS is determined as input voltage VBUS.

A positive real number greater than 0 is set as second limit value β in advance. When estimated charging power PADP_CHG is significantly greater than system supply power PSYS, voltage VBUS_CHG is determined as input voltage VBUS.

Even if system supply power PSYS and estimated charging power PADP_CHG are influenced by noise, the input voltage does not change unless the magnitude relationship between system supply power PSYS and estimated charging power PADP_CHG significantly changes. The power supply to the information processing apparatus 1 can thus be stabilized.

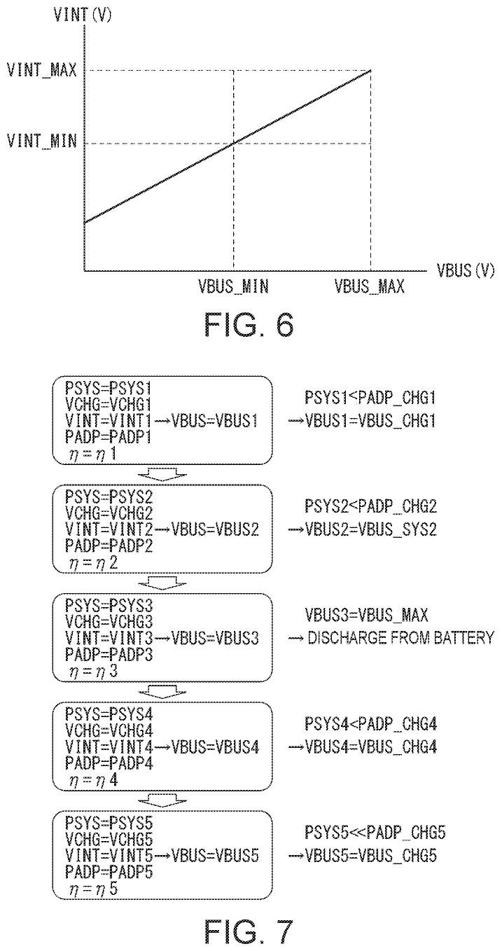

In one or more embodiments, the range of input voltage VBUS (VBUS MIN to VBUS MAX) is set so that the range of intermediate voltage VINT (VINT MIN to VINT MAX) of the intermediate power supplied from the voltage regulator circuit 334 will be in the range of the charging voltage to the battery 34 and the range of system supply voltage VSYS (see FIG. 6). The range of the charging voltage of the battery 34 and the range of the system supply voltage are typically 6 V to 20 V. In the case where the voltage ratio between input voltage VBUS and intermediate voltage VINT is 2:1, the range of input voltage VBUS is 15 V to 40 V.

Next, an example of controlling input voltage VBUS will be described below. FIG. 7 is a diagram illustrating a first control example of input voltage VBUS according to one or more embodiments. FIG. 7 illustrates transition of each of system supply power PSYS, charging voltage VCHG, input voltage VBUS determined by intermediate voltage VINT, input power PADP, and consumption efficiency η. Input power PADP corresponds to the product of input voltage VBUS and input current IVBUS. Consumption efficiencies η1 to η5 were approximately 96% to 98%, and high conversion efficiency was obtained.

In the example of the first row, system supply power PSYS1 is less than estimated charging power PADP_CHG1, so that input voltage VBUS1 is voltage VBUS_CHG1.

In the example of the second row, system supply power PSYS2 is greater than estimated charging power PADP_CHG2, so that input voltage VBUS2 is voltage VBUS_SYS2.

In the example of the third row, input voltage VBUS3 reaches maximum value VBUS MAX. If system supply power PSYS also reaches the maximum value and system supply power PSYS further increases, the power supplied from the AC adapter 37 is insufficient. The shortage of power is supplemented by using discharged power discharged from the battery 34.

In the example of the fourth row, system supply power PSYS4 is less than estimated charging power PADP_CHG4, so that input voltage VBUS4 is voltage VBUS_CHG4.

In the example of the fifth row, system supply power PSYS5 is even less than estimated charging power PADP_CHG5, so that input voltage VBUS5 is voltage VBUS_CHG5.

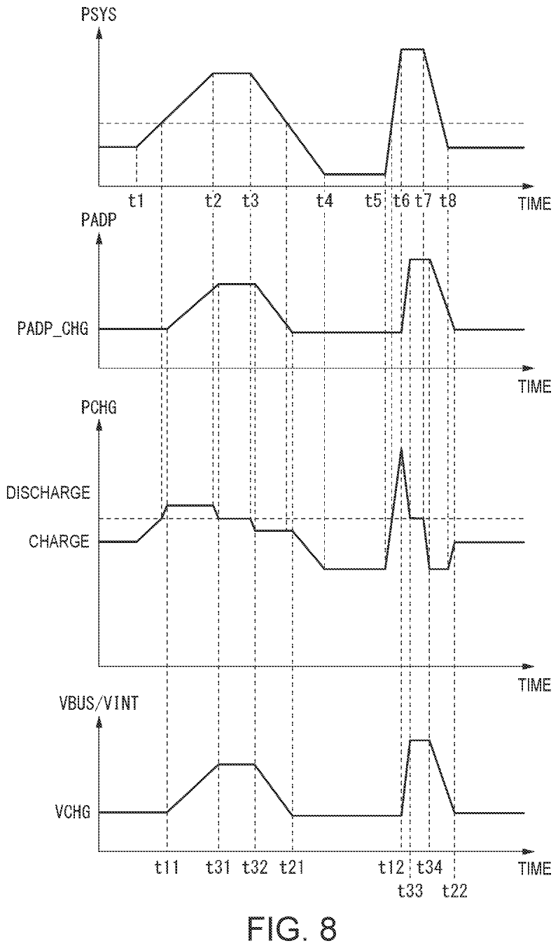

FIG. 8 is a diagram illustrating a second control example of input voltage VBUS according to one or more embodiments. FIG. 8 illustrates system supply power PSYS, input power PADP, charging power PCHG, input voltage VBUS, and intermediate voltage VINT. Charging power PCHG is the power actually charged to the battery 34. In FIG. 8, charging power PCHG decreases upward, and, in the part above the dashed line, charging power PCHG is negative, i.e. power is discharged from the battery 34. System supply power PSYS remains low until time t1, increases from time t1 to time t2, and remains high from time t2 to time t3. After this, the system supply power decreases from time t3 to time t4, remains low from time t4 to time t5, and increases sharply from time t5 to time t6. System supply power PSYS remains high from time t6 to time t7, decreases sharply from time t7 to time t8, and remains low from time t8 onward.

As system supply power PSYS increases, charging power PCHG initially decreases. When system supply power PSYS exceeds estimated charging power PADP_CHG, the state turns into discharge (see time t11 and time t12). After this, as a result of input voltage VBUS being determined as voltage VBUS_SYS, estimated charging power PADP_CHG increases. Thus, discharge is suppressed. Even when system supply power PSYS decreases again, input voltage VBUS is set to voltage VBUS_SYS for a while. Therefore, even if charging power PADP_CHG fluctuates, both discharge and charge are suppressed. When system supply power PSYS reaches estimated charging power PADP_CHG or less, input voltage VBUS is determined as voltage VBUS_CHG, as a result of which significant charge starts (see time t21). As system supply power PSYS stabilizes, the charging power stabilizes (see time t22).

Thus, according to one or more embodiments, intermediate voltage VINT can be approximated to system supply voltage VSYS by switching the input voltage estimation method depending on the magnitude relationship between system supply power PSYS and estimated charging power PADP_CHG. Moreover, by setting input voltage VBUS to voltage VBUS_SYS when system supply power PSYS exceeds estimated charging power PADP_CHG, charge and discharge of the system device SD can be suppressed.

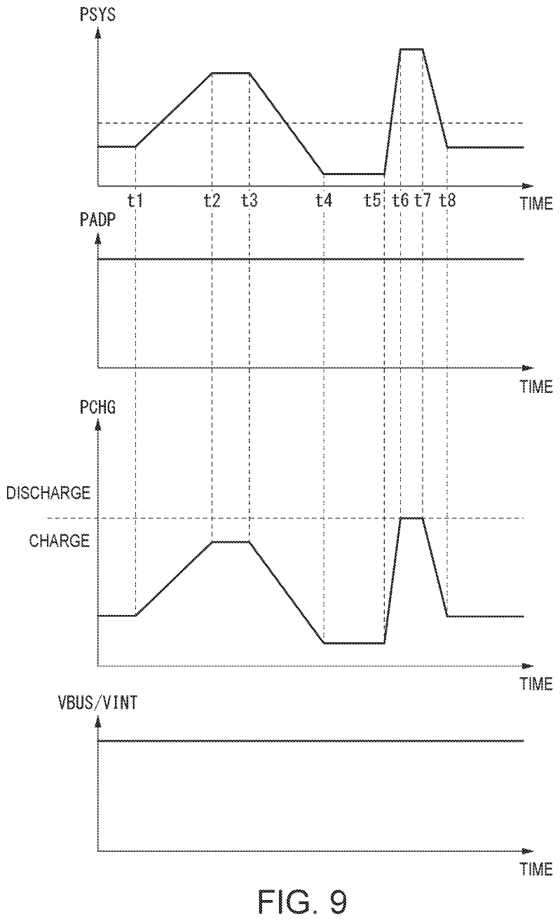

As a comparative example, a control example in which system supply power PSYS is the same as that in the example in FIG. 8 and input voltage VBUS and intermediate voltage VINT are constant is illustrated in FIG. 9. In this case, the time change of charging power PCHG corresponds to the time change of system supply power PSYS. Intermediate voltage VINT has a significant difference from system supply voltage VSYS, and charge and discharge of the system device SD are not suppressed. This causes a decrease in power consumption efficiency. In one or more embodiments, on the other hand, the time change of intermediate voltage VINT correlates with the time change of system supply voltage VSYS, and the time change of the difference between intermediate voltage VINT and system supply voltage VSYS is reduced. Therefore, the power consumption efficiency can be improved according to one or more embodiments.

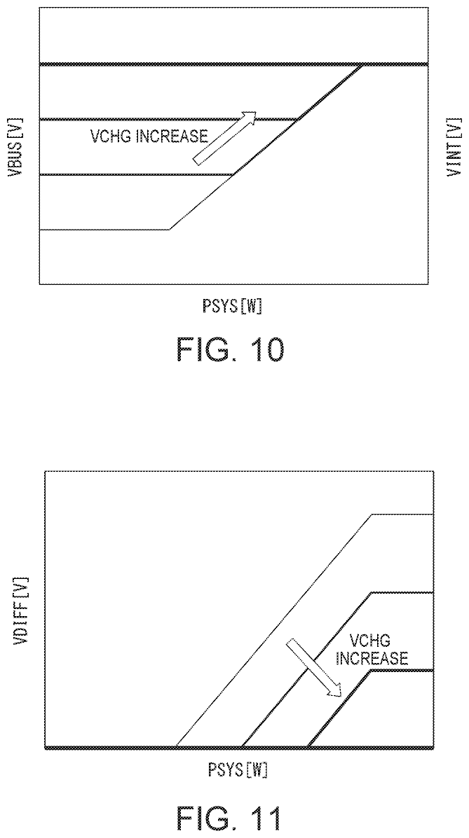

FIG. 10 is a diagram illustrating the relationship between system supply power PSYS and each of input voltage VBUS and intermediate voltage VINT according to one or more embodiments. Input voltage VBUS or intermediate voltage VINT is initially a constant value corresponding to charging voltage VCHG regardless of system supply power PSYS. When system supply power PSYS exceeds a certain value, however, input voltage VBUS or intermediate voltage VINT increases in proportion to system supply power PSYS until an upper limit is reached. In FIG. 10, the line patterns indicate differences in charging voltage VCHG. The range of system supply power PSYS in which input voltage VBUS or intermediate voltage VINT is constant is narrower when the charging voltage is lower.

FIG. 11 is a diagram illustrating the relationship between voltage difference VDIFF and system supply voltage VSYS according to one or more embodiments. Voltage difference VDIFF corresponds to the difference between intermediate voltage VINT and system supply voltage VSYS. Voltage difference VDIFF is initially zero regardless of system supply power PSYS. When the system supply power exceeds a certain value, voltage difference VDIFF increases in proportion to system supply power PSYS until an upper limit is reached. The range in which voltage difference VDIFF is zero is wider when charging voltage VCHG is higher. Given that voltage difference VDIFF causes a decrease in power consumption efficiency, higher charging voltage VCHG is preferable when system supply power PSYS required is higher.

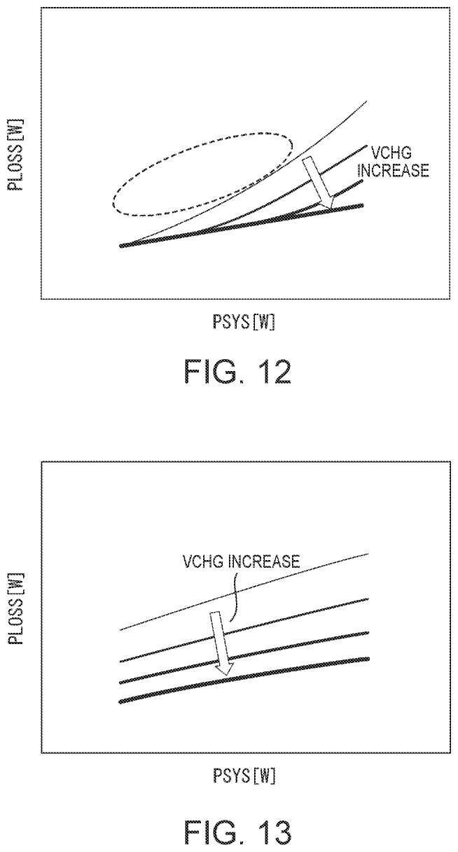

FIG. 12 is a diagram illustrating the relationship between power loss PLOSS and system supply power PSYS according to one or more embodiments. FIG. 13 is a diagram illustrating the relationship between power loss PLOSS and system supply power PSYS according to a comparative example. Power loss PLOSS tends to increase as system supply power PSYS increases. Moreover, power loss PLOSS tends to be higher when charging voltage VCHG is lower. In one or more embodiments, the increase in power loss PLOSS due to the decrease in charging voltage VCHG in the region where system supply power PSYS is small is suppressed more significantly than in the comparative example (see the dashed line part in FIG. 12). This indicates that the conversion efficiency is significantly improved especially when the power consumption of the system device SD is small.

As described above, the information processing apparatus 1 according to one or more embodiments includes: a system device SD; a controller (e.g. EC 31); a battery 34; a converter (e.g. voltage regulator circuit 334) configured to convert an input voltage into an intermediate voltage at a predetermined voltage ratio, the input voltage being a voltage of input power from a power adapter (e.g. AC adapter 37); and a power feeder (e.g. NVDC feeder 336) configured to: supply part or all of intermediate power that is power supplied from the converter, to the system device SD as system supply power; and charge the battery 34 with part of the intermediate power left unsupplied to the system device SD, as charging power. The controller is configured to: monitor a charging voltage and the system supply power, the charging voltage being a voltage of the charging power; and determine the input voltage based on the charging voltage and the system supply power.

With this structure, the intermediate voltage resulting from converting the input voltage determined based on the charging voltage and the system supply power can be approximated to the charging voltage. Hence, the power loss in the power feeder can be suppressed and the power conversion efficiency can be improved.

In the information processing apparatus 1, when the intermediate power is less than the system supply power, power discharged from the battery 34 may be supplied to the system device.

With this structure, when the intermediate power is less than the system supply power, the power discharged from the battery 34 compensates for the shortage of power. Since temporary excess or deficiency of the intermediate power is compensated for by charging or discharging the battery 34, excessive power supply from the power adapter is unnecessary.

The controller may be configured to determine the input voltage based on larger power out of the charging power and the system supply power.

With this structure, the input voltage is determined based on the charging voltage when the battery 34 is charged, and determined based on the system supply power when the battery 34 is not charged. Therefore, while approximating the intermediate voltage to the charging voltage, excessive charging and discharging can be avoided to suppress a decrease in conversion efficiency.

The controller may be configured to: change the input voltage to a system supply voltage estimated from the system supply power, when a difference between the system supply power and the charging power is greater than or equal to a predetermined first limit value; and determine the input voltage to be the charging voltage, when the difference between the charging power and the system supply power is greater than or equal to a predetermined second limit value.

With this structure, when the system power is significantly higher than the charging power, the system supply voltage is determined as the input voltage. When the charging power is significantly higher than the system supply power, the charging voltage is determined as the input voltage. Even when the magnitude relationship between the system supply power and the charging power temporarily changes, the method of determining the input voltage is unchanged. The input voltage can thus be determined stably.

The controller may be configured to estimate the charging power using the charging voltage, a reciprocal of the voltage ratio between the input voltage and the intermediate voltage, and a rated current of the power adapter.

With this structure, the charging power required to determine the input voltage can be estimated without directly measuring the charging current supplied to the battery 34.

The power adapter or the converter may include a measuring instrument configured to measure an input current.

With this structure, the charging power and consequently the input voltage can be determined regardless of fluctuation in the input current.

Although the one or more embodiments of the present invention have been described in detail above with reference to the drawings, specific structures according to the present invention are not limited to the foregoing one or more embodiments, and include design and the like within the scope of the present invention. The structures described in the foregoing one or more embodiments may be freely combined.

### DESCRIPTION OF SYMBOLS

1 information processing apparatus
11 CPU
12 main memory
13 GPU
14 display
21 chipset
22 BIOS memory
23 auxiliary storage device
24 audio system
25 WLAN card
26 USB connector
31 EC
32 input unit
33 power circuit
34 battery
36 power button
37 AC adapter
332 PD controller
334 voltage regulator circuit
334a SCVR
334b, 338 switch
336 NVDC feeder
355 temperature sensor
372 PD controller
374 rectifier
SD system device

What is claimed is:

1. An information processing apparatus comprising:
a system device;
a controller;
a battery;
a converter configured to convert an input voltage into an intermediate voltage at a predetermined voltage ratio, the input voltage being a voltage of input power from a power adapter; and
a power feeder configured to:
supply part or all of intermediate power that is power supplied from the converter, to the system device as system supply power; and
charge the battery with part of an intermediate power left unsupplied to the system device, as charging power,
wherein the controller is configured to:
monitor a charging voltage and the system supply power, the charging voltage being a voltage of the charging power; and
determine the input voltage based on the charging voltage and the system supply power.

2. The information processing apparatus according to claim 1, wherein when the intermediate power is less than the system supply power, power discharged from the battery is supplied to the system device.

3. The information processing apparatus according to claim 2, wherein the controller is configured to determine the input voltage based on larger power out of the charging power and the system supply power.

4. The information processing apparatus according to claim 3, wherein the controller is configured to:
change the input voltage to a system supply voltage estimated from the system supply power, when a difference between the system supply power and the charging power is greater than or equal to a predetermined first limit value; and
determine the input voltage to be the charging voltage, when the difference between the charging power and the system supply power is greater than or equal to a predetermined second limit value.

5. The information processing apparatus according to claim 4, wherein the controller is configured to estimate the charging power using the charging voltage, a reciprocal of the voltage ratio, and a rated current of the power adapter.

6. The information processing apparatus according to claim 4, wherein the power adapter or the converter includes a measuring instrument configured to measure an input current from the power adapter.

7. A control method executed by an information processing apparatus that includes: a system device; a battery; a converter configured to convert an input voltage into an intermediate voltage at a predetermined voltage ratio, the input voltage being a voltage of input power from a power adapter; and a power feeder configured to: supply part or all of intermediate power that is power supplied from the converter, to the system device as system supply power; and charge the battery with part of an intermediate power left unsupplied to the system device, as charging power, the control method comprising:
a first step of monitoring a charging voltage that is a voltage of a charging power and a power consumption of the system device; and
a second step of determining the input voltage based on the charging voltage and the power consumption.
